(19) United States
(12) Patent Application Publication
(10) Pub. No.: US 2003/0028431 A1
(43) Pub. Date: Feb. 6, 2003

(54) Method for adding product-purchase points

(75) Inventor: Masahiko Kawahara, Osaka (JP)

Correspondence Address: BACON & THOMAS, PLLC, 625 SLATERS LANE, FOURTH FLOOR, ALEXANDRIA, VA, 22314

(73) Assignee: MORITO CO., LTD

(21) Appl. No.: 10/118,155

(22) Filed: Apr. 9, 2002

(30) Foreign Application Priority Data
May 10, 2001 (JP) 2001-139441

(51) Int. Cl. G06F 17/60

(52) U.S. Cl. 705/14; 705/16

(57) ABSTRACT

The point provider accepts, manages and stores membership information in a membership management device (20). At the same time, the point provider attaches to each product sold a non-rewritable storage medium (e.g., a CD card (30) embedded with a CD-ROM), in which the product-specific information and the point provider's website address are written. The member inserts the CD card (30) into an information reading device (15) of a personal computer (10) to connect to the website (25) of the point provider. The point provider checks the identity of the person who has accessed the website (whether the person who has accessed the website is the same person as the one who purchased the product) and, upon confirmation, adds the points corresponding to the purchase amount and stores the point data.

### FIELD OF THE INVENTION

The present invention relates to a method for adding points that are given to a consumer when the consumer purchases a product. The points increase in accordance with the purchase amount and based on the accumulation of which the purchaser is given a discount or a prize.

### BACKGROUND OF THE INVENTION

In a widely practiced method, a store issues a membership card to a consumer who has registered as a member, and when the consumer buys a product, the points corresponding to the purchase amount are recorded on the card at the store. It is a common practice for stores to obtain data such as the consumer's address, name, sex and age through such membership registrations, and using such data, the store sends direct mail to a certain layer of the membership.

According to the above method, the points registered at a store (e.g., store A) are valid only between the store and the consumer who has registered at the store. When the same consumer buys a product of the same manufacturer at a different store (e.g., store B) that is not related to store A, the points accumulated at store A have no value at store B even though store B may have its own point registration system. In other words, if one buys products of the same manufacturer at different stores, the points accumulated at one store cannot be used at another store.

According to the above method, while information is frequently exchanged between the store and the consumers who have registered at the store, there is not much exchange of information between the manufacturer and the consumers unless the manufacturer sells its products through its own directly managed stores. For example, a manufacturer that does not operate directly managed stores may be able to grasp the distribution flow of its products from data such as the items and quantities of products shipped from its factories, but it cannot obtain specific information such as who purchased which products.

### SUMMARY OF THE INVENTION

The objective of the present invention is to make it possible for a manufacturer that does not operate directly managed stores to issue points for every purchase made by a consumer regardless of at which store the purchase was made so that the manufacturer can directly exchange information with the consumer.

In the first aspect, the present invention is characterized in that it comprises the following steps: a membership management device of the point provider accepts, manages and stores membership information; a personal computer of the member reads the information contained in a non-rewritable storage medium attached to the purchased product, in which the product-specific information and the point provider's website address are written, and connects to the website of the point provider; and the membership management device of the point-provider checks the identity of the person who accessed the website (whether the person who has accessed the website is the same person as the one who purchased the product) and, upon confirmation, adds the points corresponding to the purchase amount and stores the point data.

In the second aspect, the present invention is characterized in that it comprises the following steps: a personal computer or a mobile phone of the member accesses the website of the point provider and transmits the product identification code, which is written in a sealed document and cannot be read from outside, to the membership management device of the point provider; the membership management device of the point provider checks the identity of the person who accessed by phone (whether the person who has accessed by phone is the same person as the one who purchased the product), and upon confirmation, adds the points corresponding to the purchase amount and stores the point data.

In the first aspect, the non-rewritable storage medium is preferably a CD-ROM, in particular, a card-type CD card. As an example, a credit-card or business-card size CD card developed by Korean company CD-CARD Inc. can be used for this purpose. A DVD can also be used.

The means for confirming the identity of the person who has accessed the website (whether the person who has accessed the website is the same person as the one who purchased the product) is, for example, a combination of a product identification code printed on the surface of a non-rewritable storage medium and an electronically encrypted code written in a non-rewritable storage medium. When the accumulation of points is completed, the electronically encrypted code and the product identification code are preferably recorded as “used” so that the same non-rewritable storage medium cannot be used twice or more with the intent of gaining points.

In the second aspect, although the product identification code needs to be hidden inside a sealed document because it must not be seen from outside, the website address itself is not necessarily a secret, therefore it may be written at a position that can be seen from outside. The sealed document is, for example, an unfoldable sealed document with the product identification code written inside and is incapable of being adhesively re-folded once it is opened. Alternatively, it may be s a sealed envelope enclosing inside a document provided with the product identification code and provided with a perforation for the purpose of opening it.

In the first aspect, the combination of a product identification code printed on the surface of a non-rewritable storage medium and an electronically encrypted code written in a non-rewritable storage medium is used as a means for confirming the identity of the person who accessed the website, but in the second aspect, a product identification code inside a sealed document is by itself sufficient because the access to the website is executed by the owner of the personal computer or mobile phone.

### BRIEF DESCRIPTION OF THE DRAWINGS

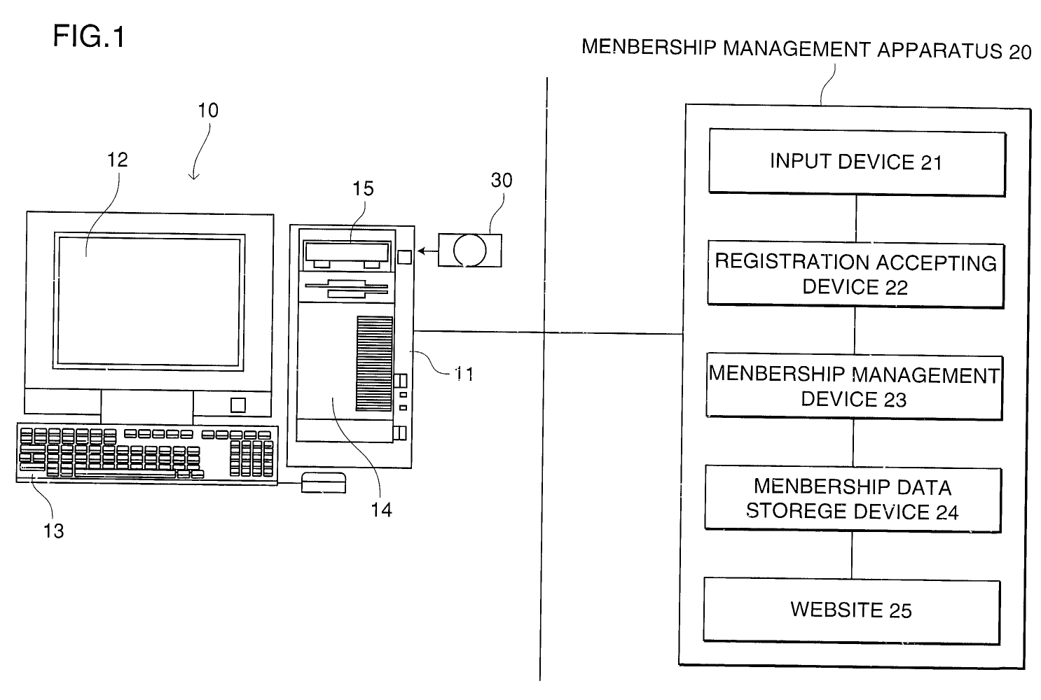

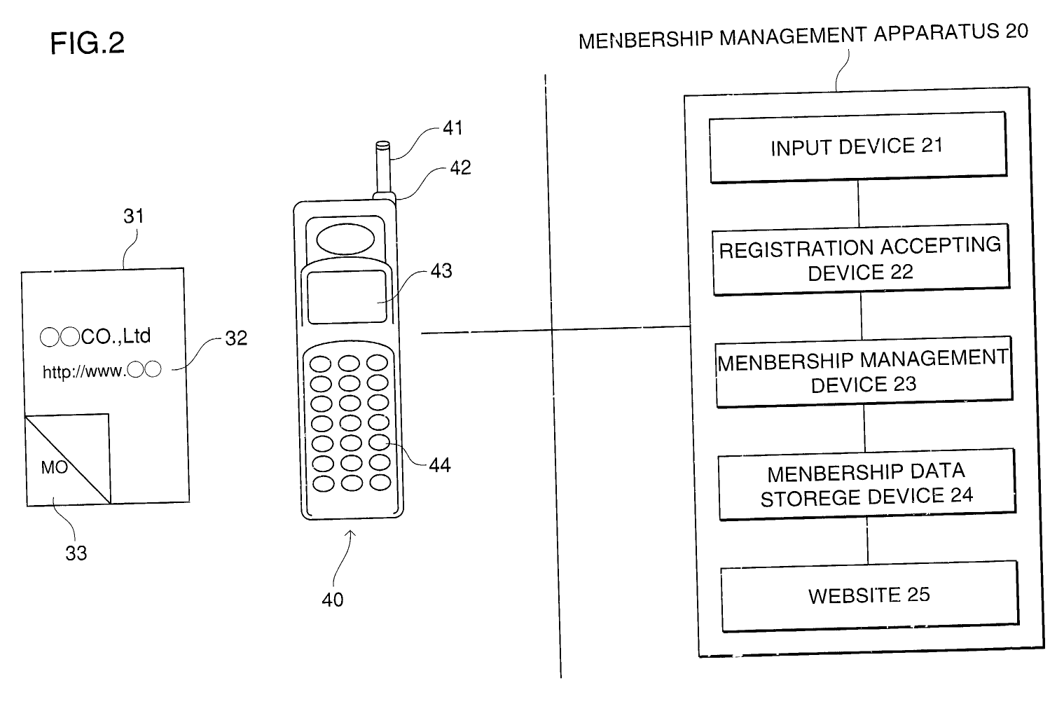

Examples of the present invention will now be described by reference to the accompanying drawings in which: FIG. 1 is a functional block diagram showing an embodiment of the system according to the first example of the present invention, FIG. 2 is a functional block diagram showing an embodiment of the system according to the second example of the present invention.

### EXAMPLES

FIG. 1 is a block diagram showing an embodiment of a system according to the first example of the present invention. This system comprises a personal computer 10 (hereinafter referred to as the “PC”) of the consumer (member) and a membership management device 20 of the point provider (hereinafter referred to as the “manufacturer” for convenience).

The PC 10 of the member includes at least a CPU (central processing unit) 11, a display 12, an input device 13 (comprising a keyboard, a mouse, etc.), a storage device (e.g., a hard disk) 14 and an information-reading device (e.g., a CD-ROM drive) 15.

The membership management device 20 of the manufacturer includes an input device (comprising a keyboard, a mouse, etc.) 21 for entering membership registration data including the address, name, sex, age, PIN number and phone number, etc., of the person who wishes to register as a member, a registration accepting device 22 for accepting the membership registration, a membership management device 23 for generally managing the membership after registration, and a membership data storage device 24 for storing the membership data.

The information entered via the input device 21 or 13 (on the consumer side) is accepted by the registration accepting device 22. The registration accepting device 22 accepts membership registration data together with individual identification data, relate them correspondingly and send them to the membership management device 23 as membership data. When registering a member, the membership management device 23 transmits the member's data from the registration accepting device 22 to the membership data storage device 24. The membership data storage device 24 also stores the accumulated points of the member.

The manufacturer has a website 25, which is linked to the membership management device 20. The website includes the manufacturer's product information page, new member registration page and point-accumulation page, etc.

Next, the mode of using this system will now be explained.

Each product for sale is provided with a tag and a CD-ROM 30 by the manufacturer in such a way that they are detachable. On the surfaces of the tag and the CD-ROM 30, information including the price, size, color, manufacturer's name and the product identification code (random numbers or serial numbers) is printed. If all necessary information can be written on the surface of the CD-ROM, the tag may not be necessary.

Inside this CD-ROM 30, the URL for accessing the website of the manufacturer and an electronically encrypted code specific to the product are written in addition to the product information. The,electronically encrypted code represents a group that the product usually belongs to, for example, a blue suit of a size M. Depending on the manufacturer, the quantity of products represented by an electronically encrypted code varies from several tens to tens of thousands. If the product is an expensive product produced in limited numbers, then the electronically encrypted code may represent that specific individual product itself. In this case, the product identification code may not be necessary.

The CD-ROM is preferably a card-type CD card 30 as shown in FIG. 1, because ordinary CDs of a diameter of 12 cm or 8 cm are too big to be attached to the product. An example of the CD card 30 is a credit-card or business-card size CD card developed by the Korean manufacturer CD-CARD Inc. This is a rectangular card embedded with a circular ROM disk in the center and can be operated by a general-purpose CD-ROM drive for computers. The diameter of the disk part is approximately 6 cm. Although the size is small, the CD card can store 30-50 MB of data, which is sufficient for text and music as well as for images.

A consumer who has bought a product places this CD card 30 into the CD-ROM drive 15 of his/her PC, which immediately reads the URL written on the CD card 30, and connects to the manufacturer's website 25 via the Internet. At this stage, the consumer can obtain general product information from the manufacturer, but because the identity of the person who has accessed the website cannot be confirmed (it is not clear whether the person who has accessed the website is the same person as the one who bought the product), points are not accumulated yet. On the screen, two choices are displayed: a new customer's course and a member's course.

If the new customer's course is chosen, the consumer is asked to register as a member first to make sure that the person who has accessed the website is the same person as the one who bought the product. Using the keyboard 13, the purchaser (i.e., the consumer) types in his/her address, full name, sex, age, telephone number, etc., in the registration application screen. Based on this registration application, the membership management device 20 of the manufacturer sends the information to the registration accepting device 22 via the input device 21. The registration accepting device 22 accepts the membership registration data together with individual identification data, relates them correspondingly and sends them to the membership management device 23 as membership data. When registering a member, the membership management device 23 transmits the member's data from the registration accepting device 22 to the membership data storage device 24. When the purchaser becomes a member, an ID number is issued. Then the purchaser is guided to the point registration screen, where he/she can enter the product identification code on the CD card to add points.

When a member purchases another product from the same manufacturer and accesses the manufacturer's website using the CD card attached to the product, he/she chooses the member's course. A screen prompting the person accessing the site to enter the ID number and the product identification code printed on the CD card appears. When the member, i.e., the purchaser, enters this data from the keyboard 13, points are added, and the fact that the points are added is displayed on the screen together with a message of appreciation for the purchase of the product.

The points added are stored in the membership data storage device 24. When the addition of the points is completed, the electronically encrypted code and the product identification code are recorded as “used”, disabling the CD card for further use for the purpose of point accumulation.

The ID number is stored on the hard disk 14 of the person who accesses the website. When he/she accesses from the same PC, the entry of this number is not necessary from the second time on. From the second time on, only the product identification code needs to be entered. The subsequent procedure remains the same.

While the PC is connected to the manufacturer's website via the CD card, various bidirectional exchanges of information are possible in addition to the accumulation of points. For example, the manufacturer can send general product information, announcement of new products and upgrade information to the members. The members can inquire as to the availability and the price of a product they want to buy as well as make complaints about product quality and request maintenance and inspection to the manufacturer.

According to the above method, member registration takes place when a consumer first accesses the manufacturer's website using a CD card, but it is also possible to register oneself as a member by filling in an application form obtainable at a store and handing it to a sales clerk or mailing it to the manufacturer, in which case membership registration is executed via the manufacturer's input device.

FIG. 2 is a functional block diagram showing an embodiment of a system according to the second example of the present invention. This system comprises a mobile phone 40 on the consumer (member) side and a membership management device 20 on the point provider (hereinafter referred to as the “manufacturer” for convenience) side.

The membership management device 20 on the manufacturer's side is the same as that used in the first example, and as such an explanation is omitted. The mobile phone 40 comprises a receiver 41, a transmitter 42, a display 43 and an input device (numerical keypad) 44.

Each product is provided with an unfoldable sealed document 31 containing a product identification code written inside and which is incapable of being adhesively refolded once it is opened. On the surface of the document, information 32 including the price, size, color, manufacturer's name, and the URL via which one can access the manufacturer's website is printed along with other information. Inside this document, the product identification code 33 (random numbers or serial numbers) for the product is written.

A consumer who has purchased a product connects to the manufacturer's website from the mobile phone 40 or his/her PC using the URL written on this document. At this stage, the consumer can obtain general product information from the manufacturer, but because the identity of the person who has accessed the website cannot be confirmed (it is not clear whether the person who has accessed the website is the same person as the one who bought the product), points are not accumulated yet. On the screen, two choices are displayed: a new customer's course and a member's course.

If the new customer's course is chosen, the consumer is asked to register first to make sure that the person who has accessed the website is the same person as the one who bought the product. Using the numerical keypad of the mobile phone 40 or the keyboard of his/her PC, the purchaser (i.e., the consumer) types in his/her address, full name, sex, age, telephone number, etc., in the registration application screen. Based on this registration application, the membership management device 20 of the manufacturer sends the information to the registration accepting device 22 via the input device 21. The registration accepting device 22 accepts the membership registration data together with individual identification data, relates them correspondingly and sends them to the membership management device 23 as membership data. When registering a member, the membership management device 23 transmits the member's data from the registration accepting device 22 to the membership data storage device 24. When the purchaser becomes a member, an ID number is issued. Then the user is guided to the point registration, where points are added when the product identification code on the CD card is entered.

When a member purchases a product from the same manufacturer and accesses the manufacturer's website using the CD card attached to the product, he/she chooses the member's course. A screen prompting the person accessing the site to enter the ID number and the product identification code printed on the CD card appears. When the member, i.e., the purchaser, enters this data from the numerical keypad, points are added, and the fact that the points are added is displayed on the screen together with a message of appreciation for the purchase of the product.

The points added are stored in the membership data storage device 24. When the addition of the points is completed, the electronically encrypted code and the product identification code are recorded as “used”, disabling the CD card for further use for the purpose of point accumulation.

### Effects of the Invention

The following effects can be achieved according to the present invention.

The manufacturer can obtain consumer (end-user) information that has previously been available only for those manufacturers operating directly managed stores. Such information can be used for the development of new products.

The consumer can accumulate points when he/she buys a product of the manufacturer at any store in Japan. If stores have their own point systems, which is quite often the case, the consumer can buy once and obtain points from two sources, the store and the manufacturer, giving the consumer a greater incentive to buy the products of the manufacturer.

When the consumer is connected to the manufacturer's website via the Internet, the consumer and the manufacturer are in a one-to-one interactive relationship. This makes possible a more carefully executed exchange of information between the consumer and the manufacturer, resulting in greater satisfaction for both parties. Moreover, this way of exchanging information can be executed more quickly than by conventional methods of communication such as direct mail. For example, when a certain number of points are accumulated, the manufacturer can send an e-mail to the purchaser directly to advise them of the fact.

According to the second aspect of the present invention, points can be accumulated using a mobile phone, allowing consumers who do not have a PC at home to use the system. It is also possible to display accumulated points or a discount ticket corresponding to the accumulated points on the mobile phone's display so that the consumer can use the ticket at a store.

1. A method for adding product-purchase points comprising the following steps:
a membership management device (20) of the point provider accepts, manages and stores membership information;
a personal computer (10) of the member reads the information contained in a non-rewritable storage medium (30) attached to the purchased product, in which the product-specific information and the point provider's website address are written, and connects to the website (25) of the point provider; and
the membership management device (20) of the point provider checks the identity of the person who accessed the website (whether the person who has accessed the website is the same person as the one who purchased the product) and, upon confirmation, adds the points corresponding to the purchase amount and stores the point data.

2. A method according to claim 1 in which the non-rewritable storage medium is a CD-ROM or a DVD.

3. A method according to either claim 1 or 2 in which the means for checking the identity of the person who accessed the website (whether the person who has accessed the website is the same person as the one who purchased the product) consists of a product identification code printed on the surface of the non-rewritable storage medium and an electronically encrypted code written in the non-rewritable storage medium.

4. A method according to any of claims 1 to 3 in which after the accumulation of points is completed the electronically encrypted code and the product identification code are recorded as “used” so that the same non-rewritable storage medium cannot be used twice or more with the intent of gaining points.

5. A method for adding product-purchase points comprising the following steps: a membership management device (20) of the point provider accepts, manages and stores membership information;
a personal computer or a mobile phone of the member accesses the website of the point provider and transmits a product identification code (33), which is written in a sealed document and cannot be read from outside, to the membership management device (20) of the point provider; and
the membership management device (20) of the point provider checks the identity of the person who accessed by phone (whether the person who has accessed by phone is the same person as the one who purchased the product), and upon confirmation, adds the points corresponding to the purchase amount and stores the point data.

6. A method according to claim 5 in which the sealed document is an unfoldable sealed document with a product identification code written inside and is incapable of being adhesively re-folded once it is opened.

7. A method according to claim 5 in which the sealed document is a sealed envelope enclosing inside a document provided with a product identification code.

8. A method according to claim 6 in which the envelope is provided with a perforation for opening the envelope.
